(19) United States
(12) Patent Application Publication
(10) Pub. No.: US 2005/0259065 A1
(43) Pub. Date: Nov. 24, 2005

(54) Back light source generator

(76) Inventors: Chin-Wen Chou, Hsin Tien City (TW); Eddie Cheng, Hsin Tien City (TW); Chin-Biau Chong, Hsin Tien City (TW)

Correspondence Address: BIRCH STEWART KOLASCH & BIRCH, PO BOX 747, FALLS CHURCH, VA, 22040-0747, US

(21) Appl. No.: 10/848,178

(22) Filed: May 19, 2004

(51) Int. Cl. G09G 3/36

(52) U.S. Cl. 345/102

(57) ABSTRACT

The present invention provides a back light source generator for solving the problem of uneven illumination and shadow of a bottom lighting type back light source. The present invention increases the brightness of light generating elements and then increases the illumination of the two outsides of the liquid crystal panel by increasing the lamp current (driving current) of the light generating elements which are nearest to two outsides of a liquid crystal panel, thereby solving the problem that the illumination of the two outsides of the liquid crystal panel is relatively lower than other regions or the whole illumination is uneven.

### FIELD OF THE INVENTION

The present invention relates to a back light source generator, and more particularly to a bottom lighting type back light source generator.

### BACKGROUND OF THE INVENTION

Light source modules can be kinds of back light module and front light module. According to the position of the incident light of the back light module, the back light modules can be kinds of edge lighting type back light module and bottom lighting type back light module. The front light module is a kind of edge lighting type front light module only.

The light efficiency of the bottom lighting type back light module is about 60%. The thickness of the module is thicker than others, and therefore the bottom lighting type back light module is often applied to a desk type liquid crystal display (LCD), a LCD TV or a non-portable electronic product. If the dimension of the LCD is larger than 17 inches, the weight of the bottom lighting type back light module is lighter than that of the edge lighting type back light module. A plurality of lamps are disposed under a light guide plate of the LCD in sequence, and therefore the outline of the lamps easily result in the problem of uneven illumination and shadow. In order to improve the problem, there are solutions to be often used as follows: providing with a light curtain or adjusting the size of a diffusion plate of the LCD, thereby eliminating the shadow of the lamps and then having more even illumination of a screen.

Referring to FIG. 1, it shows the arrangement of lamps of a bottom lighting type back light module. There are three groups of cold cathode fluorescent lamps 26, 27 and 28 which are disposed under a liquid crystal panel 1 (shown by the broken line). Referring FIG. 2, it depicts that a functional block diagram of the groups of cold cathode fluorescent lamps 26, 27 and 28 and a driving circuit thereof. A control unit 20 controls a plurality of groups of piezoelectricity units 31, 32 and 33 via a driving unit 21 and a converting unit 22. The groups of piezoelectricity units 31, 32 and 33 respectively drive the groups of cold cathode fluorescent lamps 26, 27 and 28 to illuminate, wherein the groups of cold cathode fluorescent lamps 26, 27 and 28 are connected to the groups of piezoelectricity units 31, 32 and 33.

Two illuminating regions 34, 35 are corresponding to the two groups of cold cathode fluorescent lamps 26, 28 which are near two outsides of the liquid crystal panel 1. As shown in FIG. 3, it depict that there are two kinds of brightness difference of illuminating regions. (During operation of the LCD, the groups of cold cathode fluorescent lamps which are disposed in the LCD and near two outsides of the LCD affect the brightness difference because of temperature rise.) The brightness of each illuminating region between two groups of cold cathode fluorescent lamps 26, 28 is higher than that of two illuminating regions 34, 35 which are corresponding to two groups of cold cathode fluorescent lamps 26, 28. Thus, a user feels that two illuminating regions 34, 35 which are corresponding to two groups of cold cathode fluorescent lamps 26, 28 are darker than others when the user views the illuminating regions, such that the outline of the lamps easily results in uneven illumination and shadow on the screen of the LCD.

Accordingly, there exists a need for a back light source generator capable of solving the above-mentioned problems of uneven illumination and shadow.

### SUMMARY OF THE INVENTION

It is an object of the present invention to provide a bottom lighting type back light source generator with even illumination capable of solving the problem that the illumination of the two outsides of the liquid crystal panel is relatively lower than other regions or the whole illumination is uneven, whereby a user can feel even visual effect according to the whole visual lightness.

It is another object of the present invention to provide a back light source generator for providing a liquid crystal display with a bottom lighting type back light source.

In order to achieve the foregoing objects, the present invention provides a back light source generator including a control unit, a driving unit, a converting unit, a plurality of groups of piezoelectricity units, a plurality of groups of cold cathode fluorescent lamps, wherein the control unit controls the groups of piezoelectricity units via the driving unit and the converting unit to further drive the groups of cold cathode fluorescent lamps which is design to be bottom lighting type for providing a liquid crystal panel with a back light source, and the back light source generator is characterized in that: the intensity of lamp current outputted from the two groups of piezoelectricity units which are near two outsides of the liquid crystal panel is relatively higher than that from the other group of piezoelectricity units which are utilized to drive the other groups of cold cathode fluorescent lamps, thereby solving the problem that the illumination of the two outsides of the liquid crystal panel is relatively lower than other regions or the whole illumination is uneven.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a plan view showing the arrangement of lamps of a bottom lighting type back light module in the prior art.

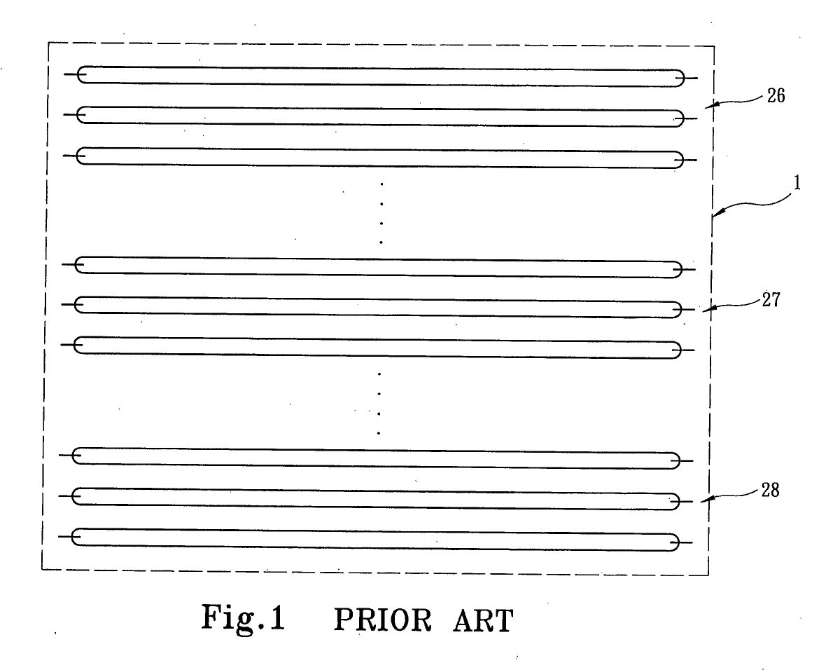

FIG. 2 is a functional block diagram of a driving circuit in the prior art.

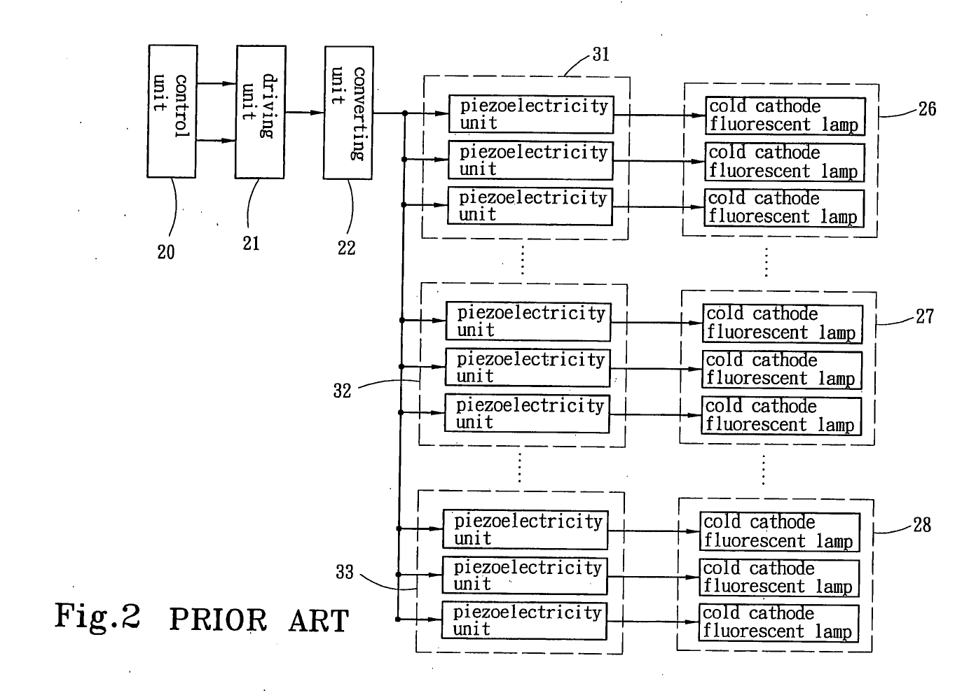

FIG. 3 is a diagram showing the brightness of cold cathode fluorescent lamps disposed at different positions shown in FIG. 1.

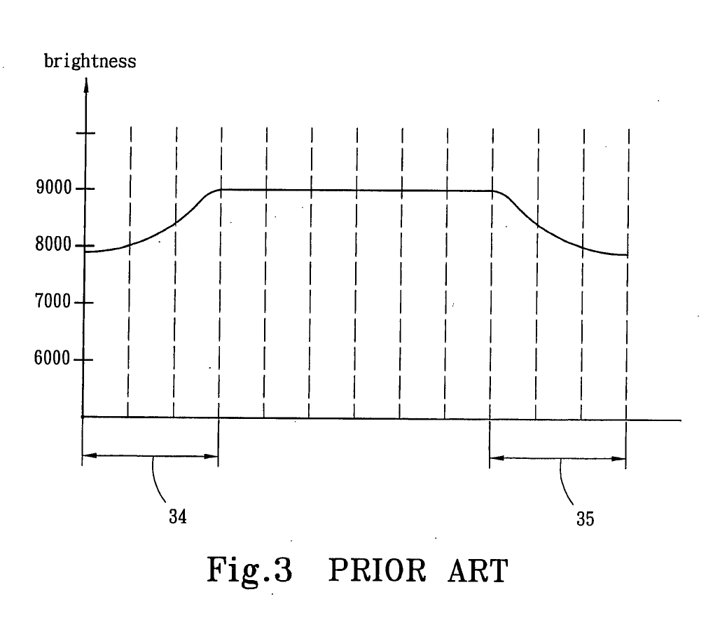

FIG. 4 is a plan view showing the arrangement of lamps of a bottom lighting type back light module according to the present invention.

FIG. 5 is a functional block diagram of a driving circuit according to the present invention.

FIG. 6 is a diagram showing the brightness of cold cathode fluorescent lamps disposed at different positions shown in FIG. 4.

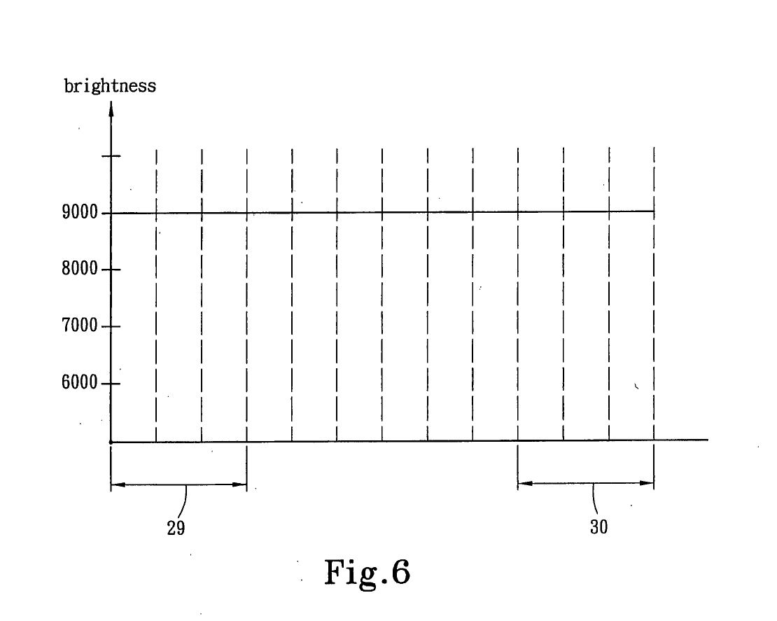

### DESCRIPTION OF THE PREFERRED EMBODIMENTS

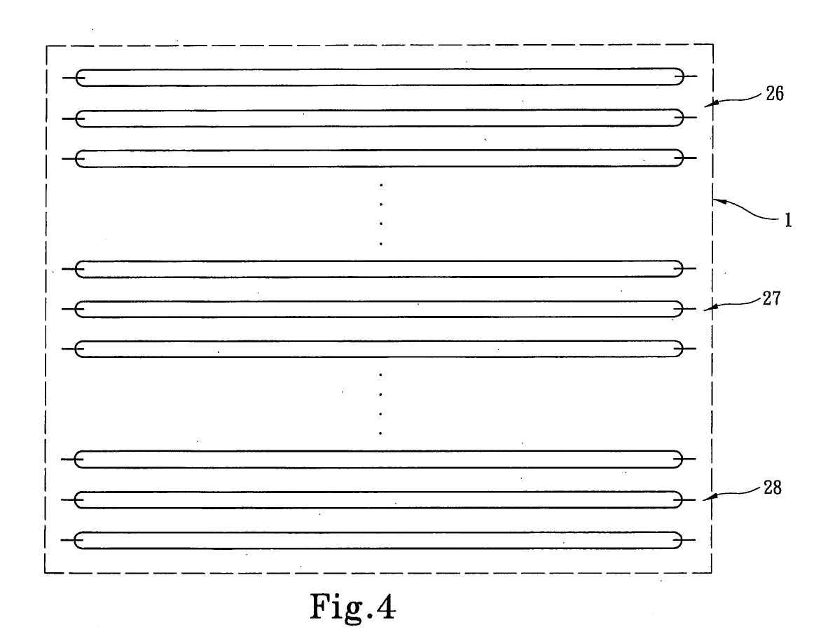

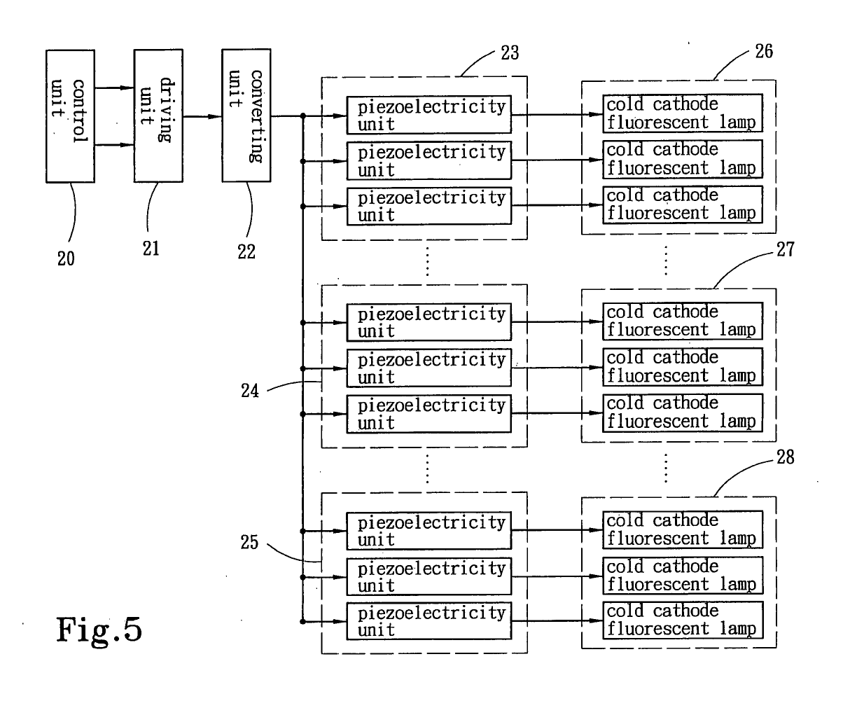

Referring to FIG. 4, it depicts that a back light source generator according to the present invention includes a plurality of cold cathode fluorescent lamps which are equidistant and parallel to one another and a driving circuit (shown in FIG. 5) which is corresponding to the cold cathode fluorescent lamps.

The cold cathode fluorescent lamps are designed by utilizing bottom lighting mode and disposed under a liquid crystal panel 1, and an illuminating region of the liquid crystal panel 1 is corresponding to three groups of cold cathode fluorescent lamps 26, 27 and 28.

In a preferred embodiment, the present invention increases the brightness by increasing the lamp current (diving current) of the two groups of cold cathode fluorescent lamps 26, 28 which are near two outsides of the liquid crystal panel 1. In other words, the present invention increases the illumination of the two outsides of the liquid crystal panel 1 by increasing lamp current (diving current) of the most outside groups of cold cathode fluorescent lamps 26, 28, thereby solving the problem that the illumination of the two outsides of the liquid crystal panel 1 is relatively lower than other regions or the whole illumination is uneven.

Referring FIG. 5, it shows that a driving circuit according to a preferred embodiment drives the groups of cold cathode fluorescent lamps 26, 27 and 28 and includes a control unit 20 which controls a plurality of groups of piezoelectricity units 23, 24 and 25 via a driving unit 21 and a converting unit 22. The groups of piezoelectricity units 23, 24 and 25 respectively drive the groups of cold cathode fluorescent lamps 26, 27 and 28 to illuminate, wherein the groups of cold cathode fluorescent lamps 26, 27 and 28 are connected to the groups of piezoelectricity units 23, 24 and 25.

The two groups of piezoelectricity units 23 and 25 are utilized to drive the two groups of cold cathode fluorescent lamps 26, 28 which are the nearest to two outsides of the liquid crystal panel 1. Oppositely, the intensity of lamp current outputted from the two groups of piezoelectricity units 23, 25 is higher than that of the group of piezoelectricity units 24 which is utilized to drive the groups of cold cathode fluorescent lamps 27. Thus, the brightness of the two groups of cold cathode fluorescent lamps 26, 28 which are the nearest to two outsides of the liquid crystal panel 1 will be increased and further the illumination of two illuminating regions 29, 30 which are corresponding to two groups of cold cathode fluorescent lamps 26, 28 being the nearest to two outsides of the liquid crystal panel 1, thereby solving the problem that the illumination of the two outsides of the liquid crystal panel 1 is relatively lower than other regions or the whole illumination is uneven.

In the preferred embodiment of the two groups of piezoelectricity units 23, 25, it is noted that choosing a kind of piezoelectricity type ceramic transformer to be the piezoelectricity unit. The piezoelectricity type ceramic transformer can easily utilize the design or change of structure thereof, such as a single-layer structure or a multi-layer structure, to generate different amount of lamp current so as to achieve the above-mentioned objective. Of course, after the technology of the present invention is understood, those skilled in the art can easily choose other equivalents, such as coil type ceramic transformer, to be realized in the present invention except the piezoelectricity type ceramic transformer. However, any equivalent conversion will be not departed from the technical scope of the present invention.

Although the invention has been explained in relation to its preferred embodiment, it is not used to limit the invention. It is to be understood that many other possible modifications and variations can be made by those skilled in the art without departing from the spirit and scope of the invention as hereinafter claimed.

1. A back light source generator including a control unit, a driving unit, a converting unit, a plurality of groups of piezoelectricity units, a plurality of groups of cold cathode fluorescent lamps, wherein the control unit controls the groups of piezoelectricity units via the driving unit and the converting unit to further drive the groups of cold cathode fluorescent lamps which is design to be a bottom lighting type for providing a liquid crystal panel with a back light source, and the back light source generator is characterized in that:
the intensity of lamp current outputted from the two groups of piezoelectricity units which are nearest to two outsides of the liquid crystal panel is relatively higher than that from the other group of piezoelectricity units which are utilized to drive the other groups of cold cathode fluorescent lamps, thereby solving the problem that the illumination of the two outsides of the liquid crystal panel is relatively lower than other regions or the whole illumination is uneven.

2. The back light source generator according to claim 1, wherein the piezoelectricity unit is a piezoelectricity type ceramic transformer.

3. The back light source generator corrector according to claim 2, wherein the piezoelectricity type ceramic transformer is a ceramic transformer with single-layer structure.

4. The back light source generator according to claim 2, wherein the piezoelectricity type ceramic transformer is a ceramic transformer with multi-layer structure.
